(19) United States
(12) Patent Application Publication
(10) Pub. No.: US 2022/0343150 A1
(43) Pub. Date: Oct. 27, 2022

(54) REINFORCEMENT LEARNING AND ACCUMULATORS MAP-BASED PIPELINE FOR WORKLOAD PLACEMENT

(71) Applicant: EMC IP Holding Company LLC, Hopkinton, MA (US)

(72) Inventors: Eduardo Vera Sousa, Rio de Janeiro (BR); Ana Cristina Bernardo de Oliveira, Rio de Janeiro (BR)

(21) Appl. No.: 17/236,625

(22) Filed: Apr. 21, 2021

(51) Int. Cl. G06N 3/08; G06N 3/04

(52) U.S. Cl. CPC G06N 3/08; G06N 3/04

(57) ABSTRACT

One example method includes running multiple iterations of a computing workload, for each iteration of the computing workload, for each iteration of the computing workload, using a reinforcement learning process to generate an initial infrastructure allocation for the computing workload, and a reward function of the reinforcement learning process generates a respective reward for each initial infrastructure allocation, running an accumulator map voting process to generate a total reward for each initial infrastructure allocation, and identifying the initial infrastructure allocation with the largest total reward and assigning that initial infrastructure allocation to the computing workload.

### FIELD OF THE INVENTION

Embodiments of the present invention generally relate to allocation of infrastructure resources to computing jobs. More particularly, at least some embodiments of the invention relate to systems, hardware, software, computer-readable media, and methods for workload placement using reinforcement learning, and an accumulators map that assigns values to different resource allocation solutions.

### BACKGROUND

Using an infrastructure efficiently to execute jobs while respecting Service Level Agreements (SLA) and, therefore, assuring Quality of Service (QoS), poses several challenges. One of such challenges lies in the fact that SLAs are set prior to the execution of a job. However, during execution of the job, the environment could be affected by several considerations, such as poor knowledge about actual resource necessity, demand peaks, and hardware malfunctions, for example. It may be nearly impossible to anticipate, and accommodate, considerations such these when formulating and implementing the SLA.

The challenge is even bigger in datacenter environments in which the configuration of the nodes may differ and restrictions may exist over gathering information for management and orchestration of resources. Moreover, since different workload may have different respective bottlenecks, some workloads may be better executed in a certain environment than in other environments.

### BRIEF DESCRIPTION OF THE DRAWINGS

In order to describe the manner in which at least some of the advantages and features of the invention may be obtained, a more particular description of embodiments of the invention will be rendered by reference to specific embodiments thereof which are illustrated in the appended drawings. Understanding that these drawings depict only typical embodiments of the invention and are not therefore to be considered to be limiting of its scope, embodiments of the invention will be described and explained with additional specificity and detail through the use of the accompanying drawings.

FIG. 1 discloses aspects of an example environment including a workload and multiple different infrastructure allocations

FIG. 2 discloses aspects of another example environment including multiple workloads and multiple infrastructure allocations.

FIG. 3 discloses an example pipeline for workload placement.

FIG. 4, FIG. 5, and FIG. 6, are reward function plots.

FIG. 7 discloses an example accumulator map configuration.

FIG. 8, FIG. 9, FIG. 10, FIG. 11, FIG. 12, FIG. 13, and FIG. 14, each disclose respective experimental results achieved with various example embodiments.

FIG. 15 is a flow diagram disclosing aspects of an example method.

FIG. 16 discloses an example computing entity operable to perform any of the disclosed methods and processes.

### DETAILED DESCRIPTION OF SOME EXAMPLE EMBODIMENTS

Embodiments of the present invention generally relate to allocation of infrastructure resources to computing jobs. More particularly, at least some embodiments of the invention relate to systems, hardware, software, computer-readable media, and methods for workload placement using reinforcement learning, and an accumulators map that assigns values to different resource allocation solutions. For example, one approach for dealing with the intra-nodes adaptation of resource allocation is to use reinforcement learning-based agents. Thus, some example embodiments provide a pipeline for workload placement using a reinforcement-learning approach and the concept of accumulators map using reward as voting weight.

In more detail, some example embodiments may involve a reinforcement learning-based approach, combined with an accumulators map voting scheme, to provide stability for the solution. Initially, an algorithm, such as a Deep Q-Network (DQN) reinforcement learning (RL) algorithm for example, may be used to provide a good initial guess for the infrastructure of hardware and/or software needed to support execution of a job, or workload. This first model may consider each infrastructure as a possible state for the RL algorithm environment. The reward function may take the form of a function that provides a reward having a positive value if the execution time of a workload is less than or equal to a time specified in an SLA. If the execution time exceeds the time specified in the SLA, the reward has a negative value. As well, provision may be made for a discount factor when the execution time is smaller than SLA expected time, which reflects the situation of allocating an infrastructure whose capabilities exceed the needs of the workload. The training may be performed considering the execution of a single workload per infrastructure. Once the training is completed, the model may be able to estimate the best infrastructure to run a workload.

Embodiments of the invention, such as the examples disclosed herein, may be beneficial in a variety of respects. For example, and as will be apparent from the present disclosure, one or more embodiments of the invention may provide one or more advantageous and unexpected effects, in any combination, some examples of which are set forth below. It should be noted that such effects are neither intended, nor should be construed, to limit the scope of the claimed invention in any way. It should further be noted that nothing herein should be construed as constituting an essential or indispensable element of any invention or embodiment. Rather, various aspects of the disclosed embodiments may be combined in a variety of ways so as to define yet further embodiments. Such further embodiments are considered as being within the scope of this disclosure. As well, none of the embodiments embraced within the scope of this disclosure should be construed as resolving, or being limited to the resolution of, any particular problem(s). Nor should any such embodiments be construed to implement, or be limited to implementation of, any particular technical effect(s) or solution(s). Finally, it is not required that any embodiment implement any of the advantageous and unexpected effects disclosed herein.

In particular, one embodiment of the invention may provide optimum resources for the execution of a workload. An embodiment may help to avoid, or reduce, oscillation between two or more possible solutions. An embodiment may help to avoid, or reduce, SLA violations. Various other useful aspects that may be implemented by one or more embodiments are disclosed elsewhere herein.

It is noted that embodiments of the invention, whether claimed or not, cannot be performed, practically or otherwise, in the mind of a human. As indicated by the illustrative examples disclosed herein, embodiments of the invention are applicable to, and find practical usage in, environments in which large numbers, such as hundreds or thousands for example, of workloads and job execution resources may be handled and processed by the disclosed systems. Such handling and processing is well beyond the mental capabilities of any human to perform practically, or otherwise. Thus, while other, simplistic, examples may be disclosed herein, those are only for the purpose of illustration and to simplify the discussion. Accordingly, nothing herein should be construed as teaching or suggesting that any aspect of any embodiment of the invention could or would be performed, practically or otherwise, in the mind of a human.

### A. Overview

Cloud computing has gained the attention of businesses because of its benefits, which include pay-per-use computation at the customer side, and resource sharing at the provider side. Through virtualization, the main technology behind clouds, it is possible to abstract a pool of computation devices and offer computational resources better tailored to customer needs, who might contract for more computation as their necessities grow. In this environment, other resource abstractions emerged, the most prominent example being containers. It is also possible to offer computing without the customer knowledge about what underlying infrastructure is running their code. This may be achieved, for example, in the Platform as a Service (PaaS) paradigm and the Function as a Service (FaaS, serverless computing) paradigm.

In each of these paradigms, the usual agreements upon quality of service (QoS) expected by the customer are typically expressed through several Service Level Agreements (SLAs). An SLA typically includes response time, execution time, uptime percentage, among other metrics. The SLAs are usually agreed upon between the provider and customer prior to provision of the service to the customer. The agreement may be expressed in the form of target metrics reference values. Providers aim at respecting these targets in order to avoid contractual fines. Furthermore, failing to meet the targets also diminishes the perceived trust of the provider by the customer.

One approach to ensuring SLA compliance is to dedicate a large, static, amount of resources to each customer. However, there are problems with this approach. For example, an application generally cannot be assumed to be bounded by one particular resource. Some applications, for example, might have an IO-intensive phase and, afterwards, a compute-intensive phase. Dedicating a large amount of all resources to an application in often inefficient, resulting in spare resources at the different phases of the application. On the other hand, the initial guess on how much resources are needed to run an application might be overestimated, or underestimated.

Further, assuming that a provider with a large pool of computational resources any particular application does not need to care about resource constraints (i.e. from the point of view of the application, more resources are always available within reasonable limits established by the SLA). However, from the point of view of the provider who deals with many customers concurrently, the volume of spare resources dictates how many jobs can be run in parallel while respecting SLAs. Thus, another problem is that optimizing the adaptation of resource allocation of a single job impacts the efficiency of the entire system.

In contrast with SLAs, which are typically set prior to the execution of a job, the execution environment is quite dynamic. New workloads might compete for resources, and unplanned demand peaks might occur, which could disrupt the original workload planning due to tasks with higher priorities, greater needs to share the environment and overheads because of context switching. Service providers always aim to provide services to their customers respecting SLAs and minimizing resource usage. This is the scenario that provides the optimal profit for the provider. To do so, a static approach of allocation, which dedicates resources to a job from its start through its completion, is naturally inefficient, and, thus, sub-optimal, at least from the perspective of the provider.

In view of considerations such as those noted, example embodiments of the invention include methods for the workload placement problem considering an infrastructure that does not allow changes to parameters, such as number of cores, amount of memory, and number of GPUs (Graphics Processing Unit) devices for example, during the execution of the workload. Thus, some embodiments may differ from approaches that involve dynamic allocation of resources. In general, example embodiments may employ an RL (Reinforcement Learning) algorithm to find the best allocation associated to an accumulators map to provide stability to the method. Further, experimental data indicates that the approach implemented by example embodiments is scalable and performs well, even in a noisy environment.

### B. Overview

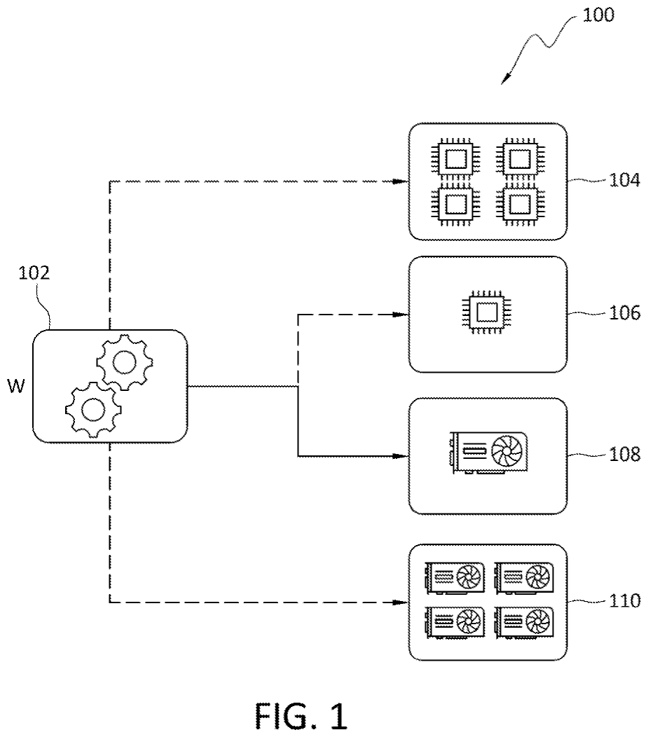

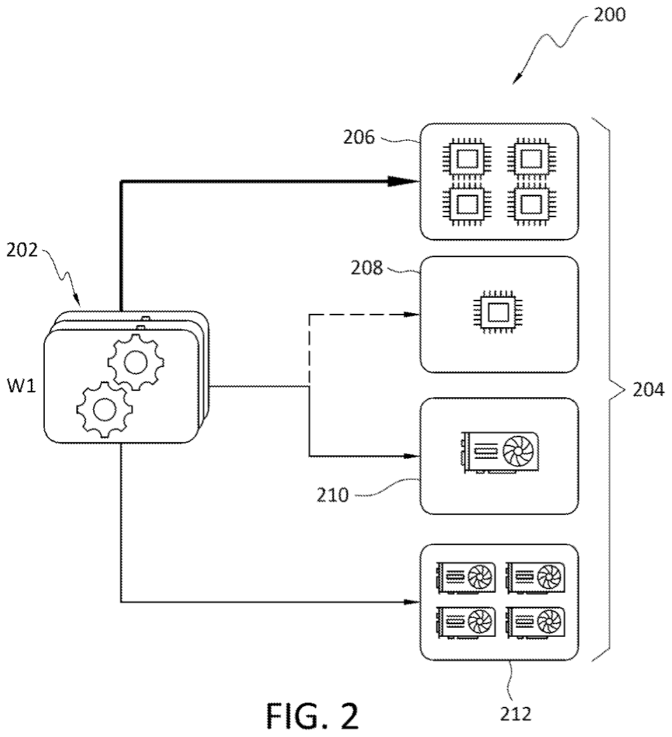

With reference now to FIGS. 1 and 2, details are provided concerning some comparative examples that may help to illustrate certain aspects of some embodiments of the invention. In the example environment 100 of FIG. 1, a workload 102 is identified that requires execution. Any of a number of possible different infrastructures 104, 108, 108, and 110, may be able to execute the workload ‘W’ 102. Thus, there is a need to identify an optimal match between the workload ‘W’ 102 and one of the infrastructures 104, 106, 108, and 11. That is, a suitable infrastructure must be identified to execute the workload ‘W’ 102 in a way that meets the requirements of any applicable SLAs, while also employing infrastructure in an efficient way. Circumstances such as these may be referred to as constituting a workload placement problem.

For a single workload as shown in FIG. 1, and ignoring concurrency of other workloads, the problem of workload placement may be relatively simple. In a real world environment 200, such as the example of FIG. 2, the problem is considerably more complex as there may be any number ‘n’ of workloads ‘W1’ 202 starting and ending at any time. Further complicating matters may be the fact that there is a concurrent need for the resources 204 by the multiple workloads ‘W1’ 202. That is, each workload included in the workloads ‘W1’ 202 may have to be allocated to a respective infrastructure 206, 208, 210, and 212. Thus, the environment 200 may be dynamic, as compared with the environment 100.

As particularly indicated by the comparative example of Figure, fulfillment of customer contracts, that is, SLAs, may be challenging. Even though some knowledge of future workloads could exist, and a demand prediction engine may provide some insight, errors with workload allocations inevitably occur, and such errors may threaten the ability of the provider to comply with other SLAs even where those other SLAs do not suffer from workload allocation errors. Furthermore, the execution of new workloads may impact on the execution time of other workloads that are already running. Recently added devices to infrastructures or unavailability of devices, such as due to malfunctions for example, may also lead to SLA violations.

One approach to addressing concerns such as those noted above might to ensure SLA compliance by dedicating a certain amount of resources to a particular job. However, while this approach might lead to complete fulfillment of an SLA, it is not a cost-effective approach. For example, workloads might have different necessities, and might be relatively intensive with respect to consumption of one resource, but not as intensive with respect to consumption of other resources. To dedicate devices for some workloads is not suitable in both ends of the demand spectrum. On the one hand, there is the situation when demand is low and dedicating resources is possible, but not cost-effective since the resources may be underutilized. On the other hand, if demand is high, dedicating resources will lead to fewer workloads executed over time, which reduces the overall throughput of the provider, and this is reflected in less revenue generated.

### C. Aspects of Some Example Operating Environments

Following is a discussion of aspects of example operating environments for various embodiments of the invention. This discussion is not intended to limit the scope of the invention, or the applicability of the embodiments, in any way.

In general, embodiments of the invention may be implemented in connection with systems, software, and components, that individually and/or collectively implement, and/or cause the implementation of, operations such as, but not limited to, data read/write/delete operations, data deduplication operations, data backup operations, data restore operations, data cloning operations, data archiving operations, disaster recovery operations, and any operations that may be performed in a cloud computing environment.

New and/or modified data collected and/or generated in connection with some embodiments, may be stored in a data protection environment that may take the form of a public or private cloud storage environment, an on-premises storage environment, and hybrid storage environments that include public and private elements. Any of these example storage environments, may be partly, or completely, virtualized. The storage environment may comprise, or consist of, a datacenter which is operable to service read, write, delete, backup, restore, and/or cloning, operations initiated by one or more clients or other elements of the operating environment. Where a backup comprises groups of data with different respective characteristics, that data may be allocated, and stored, to different respective targets in the storage environment, where the targets each correspond to a data group having one or more particular characteristics.

Example cloud computing environments, which may or may not be public, include storage environments that may provide data protection functionality for one or more clients. Another example of a cloud computing environment is one in which processing, data protection, and other, services may be performed on behalf of one or more clients. Some example cloud computing environments in connection with which embodiments of the invention may be employed include, but are not limited to, Microsoft Azure, Amazon AWS, Dell EMC Cloud Storage Services, and Google Cloud. More generally however, the scope of the invention is not limited to employment of any particular type or implementation of cloud computing environment.

Devices in the operating environment may take the form of software, physical machines, or VMs, or any combination of these, though no particular device implementation or configuration is required for any embodiment. Similarly, data protection system components such as databases, storage servers, storage volumes (LUNs), storage disks, replication services, backup servers, restore servers, backup clients, and restore clients, for example, may likewise take the form of software, physical machines or virtual machines (VM), though no particular component implementation is required for any embodiment. Where VMs are employed, a hypervisor or other virtual machine monitor (VMM) may be employed to create and control the VMs. The term VM embraces, but is not limited to, any virtualization, emulation, or other representation, of one or more computing system elements, such as computing system hardware. A VM may be based on one or more computer architectures, and provides the functionality of a physical computer. A VM implementation may comprise, or at least involve the use of, hardware and/or software. An image of a VM may take the form of a .VMX file and one or more .VMDK files (VM hard disks) for example.

As used herein, the term ‘data’ is intended to be broad in scope. Thus, that term embraces, by way of example and not limitation, data segments such as may be produced by data stream segmentation processes, data chunks, data blocks, atomic data, emails, objects of any type, files of any type including media files, word processing files, spreadsheet files, and database files, as well as contacts, directories, sub-directories, volumes, and any group of one or more of the foregoing.

Example embodiments of the invention are applicable to any system capable of storing and handling various types of objects, in analog, digital, or other form. Although terms such as document, file, segment, block, or object may be used by way of example, the principles of the disclosure are not limited to any particular form of representing and storing data or other information. Rather, such principles are equally applicable to any object capable of representing information.

### D. Aspects of Some Example Embodiments

As noted earlier, at least some embodiments of the invention comprise a reinforcement learning-based approach combined with an accumulators map voting scheme to provide stability for the solution. To this end, a DQN reinforcement algorithm may be employed to provide a good initial guess for the infrastructure needed to execute a workload. This approach considers each infrastructure as a possible state for the RL algorithm environment. The reward function may provide a positive reward value if the execution time of a workload is less than or equal to an execution time specified in an SLA, and a negative reward value if the execution time exceeds the execution time specified in the SLA. A discount factor may be applied when the execution time is smaller than SLA expected time, which may reflect a circumstance where the infrastructure allocated to a workload exceeds the needs of that workload.

The training may be performed considering the execution of a single workload per infrastructure. Once the training is completed, the model may be able to estimate the best allocation for a workload. It is noted that this model may be trained for a single workload running in the entire infrastructure. Additionally, the recommendation as to infrastructure resources to be allocated can have an oscillatory behavior since the ideal infrastructure for a workload may not always be available. To illustrate, a workload may need 3 cores to meet an SLA, but the two infrastructures that are available may have 2 cores and 5 cores, respectively, neither of which matches exactly with the needed 3 cores. Thus, in this example, the recommendation for infrastructure allocation may oscillate between a recommendation of the first and a recommendation of the second infrastructure. In order to provide stability to the model, embodiments of the invention may further employ an accumulators map voting scheme, some embodiments of which may be similar to a Hough Transform voting scheme (see, e.g., Hough, P.V.C., Method and Means for Recognizing Complex Patterns, U.S. Pat. No. 3,069,654, Dec. 18, 1962). One example voting process is defined by the algorithm below.

### D.1 Voting

Algorithm inputs: (1) array containing pairs (a,r) the infrastructure allocations (a), and associated respective rewards (r) associated with the infrastructure allocations; and, (2) the number (k) of possible infrastructures, where the range is 0-k.
FUNCTION:
   vote([(a,r)₁, (a,r)₂, . . . (a,r)_{y}], k) {, and A is an array with k slots initialized with zeros,
   For each pair (a,r), do:

A[a]←A[a]+r
Return arg max A

This algorithm will return the infrastructure allocation a that has the highest associated reward r. In general, and as discussed in more detail elsewhere herein, a negative reward may be associated with an allocation a that fails to meet one or more SLA requirements. An allocation a that results in over-performance, for example an execution time that is faster than required by an SLA, may have an associated reward of zero, or nearly zero. Finally, an allocation a that results in an exact match with an SLA requirement may have the maximum reward value r.

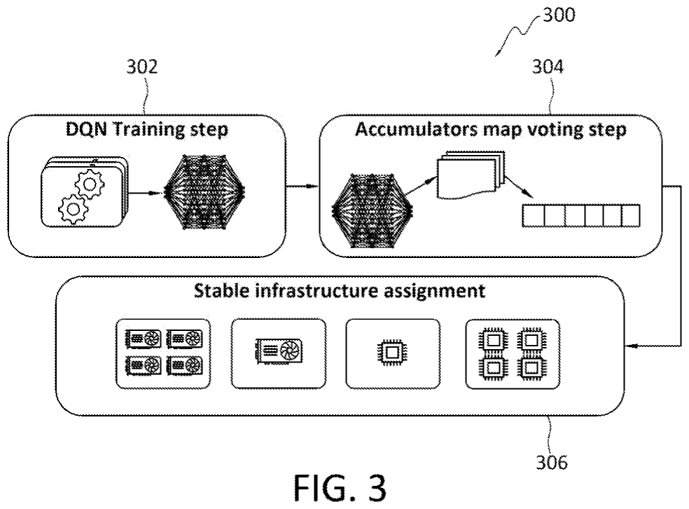

It is noted that although the training of the RL algorithm may be performed based on the running of a single workload, the voting process may provide scalability for the algorithm. Particularly, multiple workloads running in the same infrastructure may impact the execution time of a workload, thus returning a small reward to be considered in the voting scheme. One example pipeline 300 for workload placement according to some embodiments is disclosed in FIG. 3. In brief, the example pipeline 300 may comprise a DQN training process 302, the results of which may be used to inform an accumulators map voting process 304. The results of the DQN training process 302 and accumulators map voting process 304 may be used to make infrastructure assignments 306 to one or more workloads. Further information concerning components of the example pipeline 300 is provided elsewhere herein.

### D.2 Reward Function

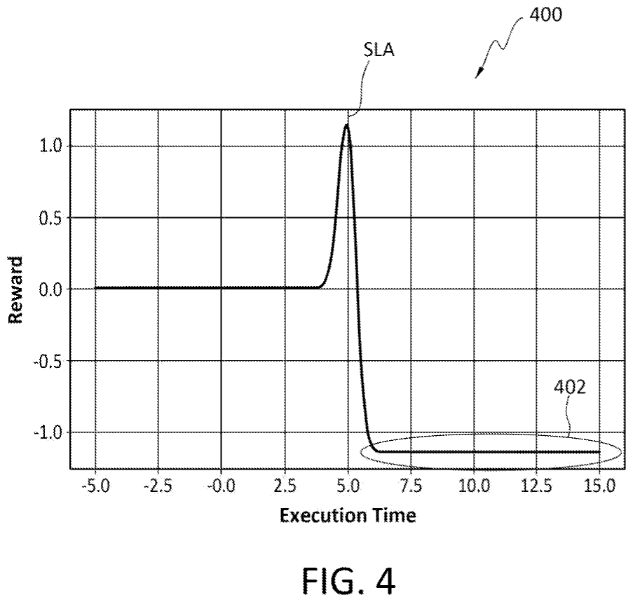

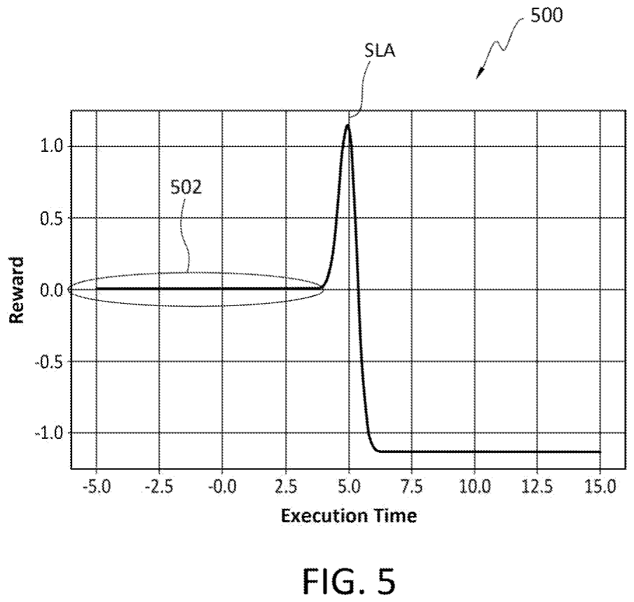

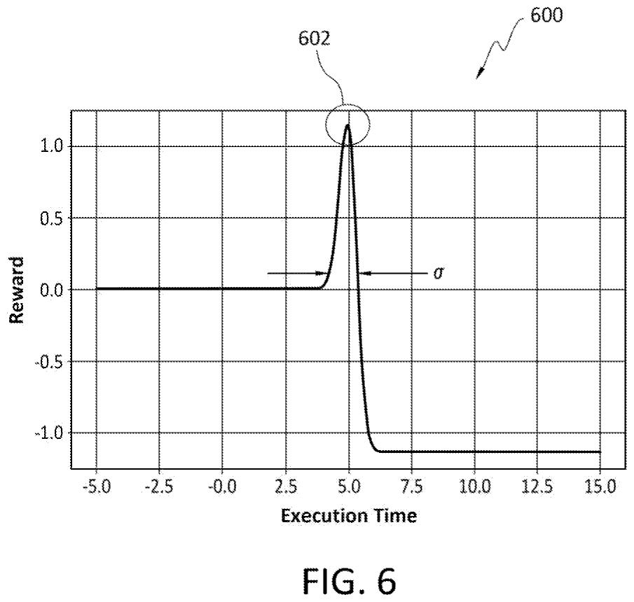

The reward function is an example approach for capturing an expected impact of an SLA violation with respect to execution time of a portion of the workload given a generic infrastructure. In some embodiments, it is assumed that the state space does not grow exponentially. The usage of an infrastructure is reflected directly in the execution time of each workload, and this behavior is mapped in the reward function. In some example experiments, an epoch of a DNN training workload is considered as a portion of a workload. One example reward function is given by:

$$f ( x , μ , σ ) = \{ \begin{matrix}\frac{1}{σ \sqrt{2 π}} {e}^{\frac{- {( x - μ )}^{2}}{2 {σ}^{2}}} , & if x < μ \\ \frac{2 {e}^{\frac{- {( x - μ )}^{2}}{2 {σ}^{2}}} - 1}{σ \sqrt{2 π}} , & otherwise\end{matrix} ,$$

where x is the execution time of an epoch of the workload, μ is the SLA requirement (such as an execution time of 5.0 seconds for example), and σ is a parameter that defines how fast the curve decays. Put another way, σ defines the width of a reward band, examples of which are disclosed in FIGS. 4-6 discussed below. Finally, it is noted that no particular reward function is necessarily required for any embodiment, and the foregoing reward function is provided only by way of example.

In general, the example reward function is structured so that the size of a reward is a function of the execution time of a workload, and the execution time of the workload may be a function of the resources allocated to that workload. Thus, a particular reward function value may reflect how well the allocated resources correlate match up with the workload that those resources execute. A reward may have a positive value, a zero value, or a negative value.

These concepts are illustrated in the example reward function graph 400 in FIG. 4, where execution time is shown on the X-axis, and the magnitude of the reward is shown on the Y-axis. The SLA time value in the example of FIG. 4 is 5.0 seconds. Thus, an execution time less than or equal to 5.0 meets the SLA, while an execution time greater than 5.0 constitutes an SLA failure. As shown in the portion 402 of FIG. 4, the reward for execution times greater than the SLA decays quickly to a strongly negative value.

With reference next to the example reward function graph 500 of FIG. 5, the portion 502 indicates a reward value of zero for execution times that are significantly faster than the SLA requirement. An execution time faster than the SLA requirement is preferable to a failure to meet the SLA requirement, but may suggest that excessive resources were allocated to the workload, particularly where the execution time is significantly faster than the SLA requirement. This is reflected in the zero reward value.

Turning now to FIG. 6, an example reward function graph 600 includes a portion 602 that identifies part of a range, or band, o of maximum reward values. The relatively high reward values in the portion 602 reflect that infrastructure was allocated relatively efficiently to the workload. Put another way, on the one hand, excessive infrastructure was not allocated to the workload, while on the other hand, infrastructure adequate to meet the SLA was allocated. Note that the band o embraces, in the example of FIG. 6, some execution times that are faster than the SLA requirement, as well as some execution times that are slower than the SLA requirement. This result may reflect a judgment that so long as the execution time is within, for example, about 5% of the SLA requirement, the execution time is considered as having met the SLA. Thus, some of the times that are slower than the SLA requirement may nonetheless have a reward value greater than zero. Finally, as shown in the example of FIG. 6, the reward value may drop off relatively quickly once the execution time exceeds the SLA requirement. Likewise, the reward value may increase relatively quickly once the execution time falls within a range of execution times that are faster than, but sufficiently close to, the SLA requirement.

As illustrated by the examples of FIGS. 4-6, a graph of a reward value may include three elements or portions. The first portion, which may be relatively wide, of reward values=0 indicates excessive allocation of resources relative to the workload, that is, some level of wasted resources that could have been allocated to another workload. The next portion of reward values may be a relatively narrow band in which reward values are at a maximum when the execution time is relatively close to the SLA requirement. The final portion of reward values may, again, be relatively wide, and the reward values may be negative, indicting that the SLA requirement was not met, that is, an SLA violation has occurred. The violation may have been the result of inadequate allocation of resources to the workload in question.

### D.3 Accumulators Map

As noted elsewhere herein, an accumulators map may be used as a mechanism to stabilize the infrastructure assignment when multiple workloads are running at the same time. Such stabilization means that there may be little, or no, oscillation between two or more possible infrastructure allocations to a workload.

In some embodiments, a process may begin with running a few iterations, such as 3-5 for example, of a workload and collecting, for each iteration, the samples (a,r)ᵢ for recommended infrastructure assignments and rewards, respectively. The range of possible values for a may be (0, k), where each a value corresponds to a specific respective infrastructure of a total of k possible infrastructures. That is, for each of the iterations, an infrastructure allocation and associated reward are determined. For the k possible states, that is, the k possible infrastructures that may be assigned, the accumulators may each be initialized with zero so as to enable comparison of different infrastructures after the iterations of the workload have been completed.

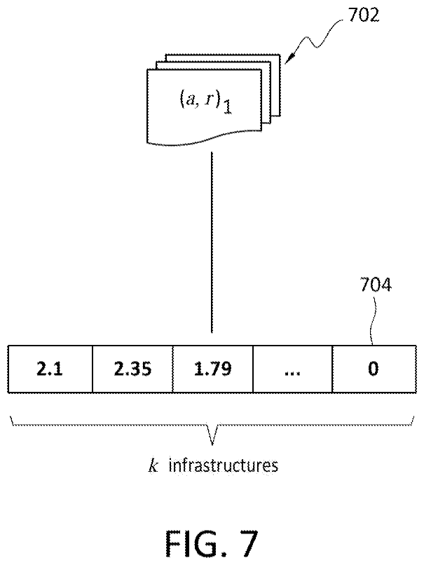

With particular reference to the example architecture 700 of FIG. 7, it can be seen that there are pair sets (a,r)ᵢ 702 where i is the number of iterations of the workload, and i can be any number. That is, for each iteration, a pair (a,r) is generated. Note that not every one of the different k possible infrastructures need be assigned to an iteration. One illustrative process may produce the results indicated below:

| Iteration | a | r |
|---|---|---|
| # 1 | 1 | 2 |
| # 2 | 3 | 6 |
| # 3 | 2 | 20 |
| # 4 | 3 | 6 |
| # 5 | 3 | 6 |

As indicated in this example, the infrastructure with k=1 has a total reward of 2, for k=2 the total reward is 20, and for k=3 the total reward is 18 (6+6+6). Thus, the infrastructure with k=2 results in the greatest total reward and, as such, should be applied to the workload.

This approach is indicated in FIG. 7 which discloses a voting process for the accumulators map 704. Particularly, once all samples have been voted in the accumulators map 702, the cell with the highest value may be selected. The address of the cell in the accumulator corresponds to the best suited allocation, which is k=3 (with r=2.35) in FIG. 1. This process may be repeated for each one of the n workloads in the queue to be processed. Because multiple iterations may be run for each workload, the process may mitigates the oscillation problem and provide a good match between a workload and infrastructure. In practice, the algorithm may only need to run when starting or ending a workload.

### E. Experimental Results

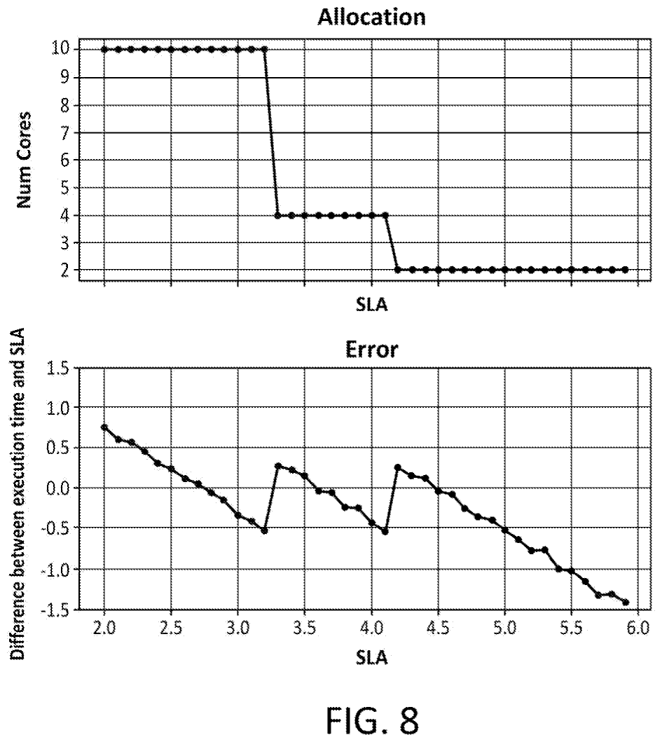

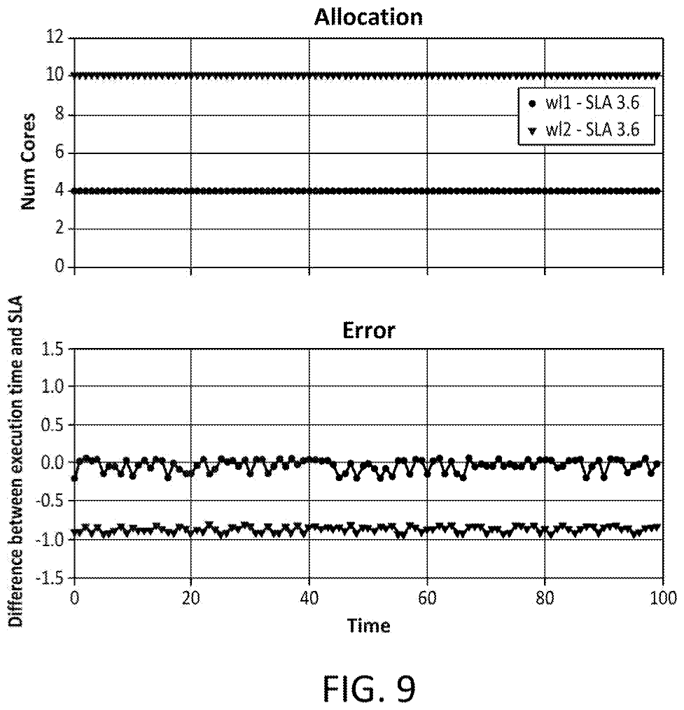

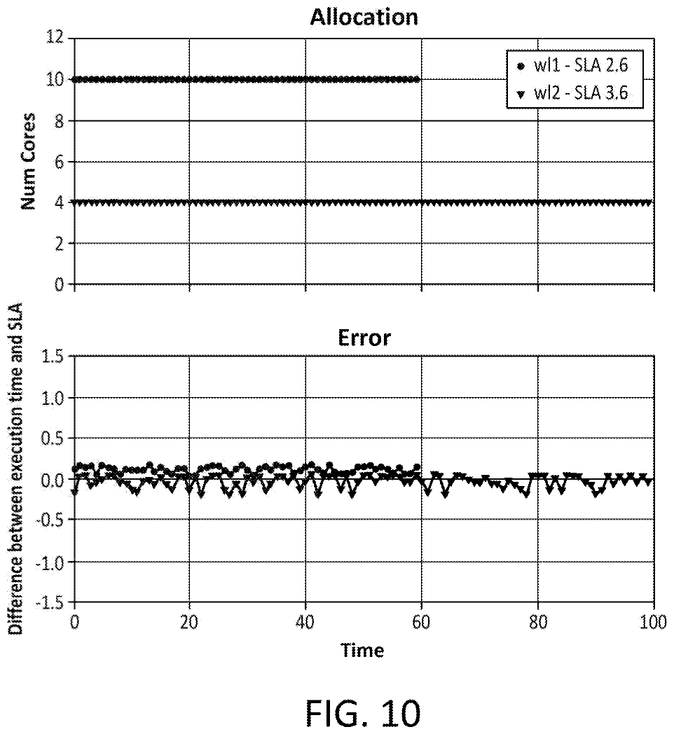

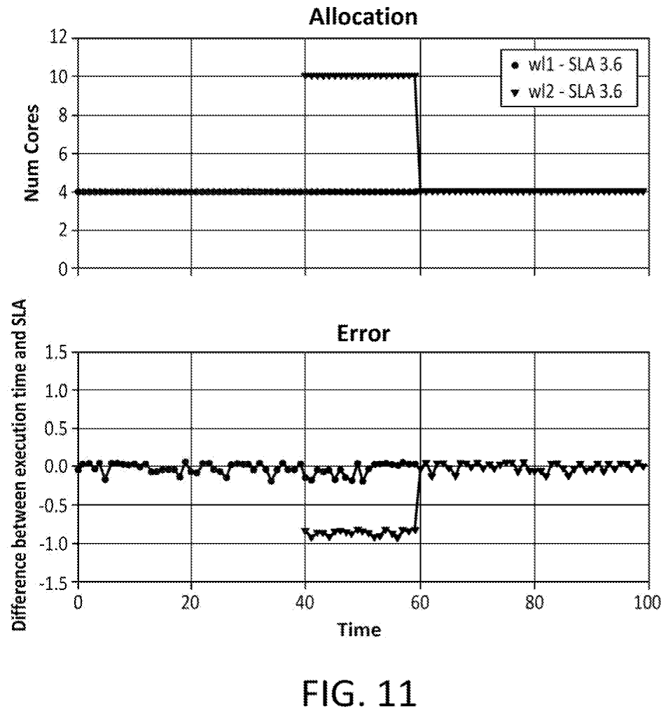

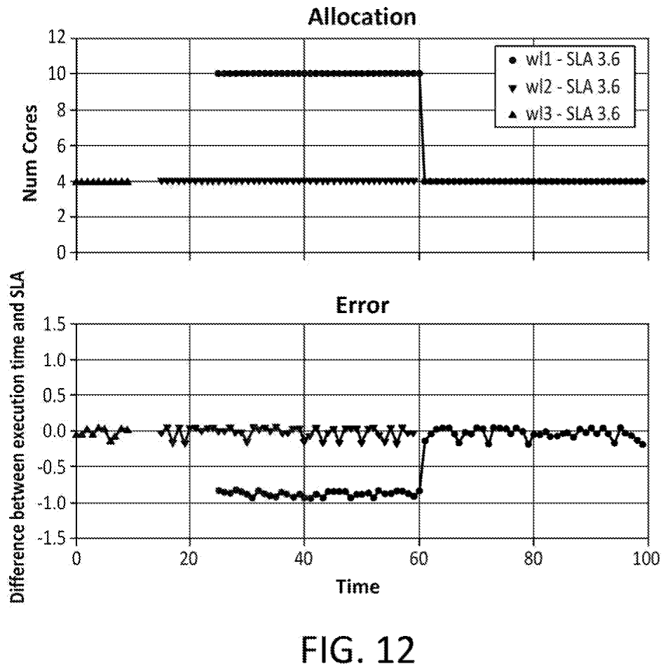

With reference now to FIGS. 8-14, various experiments were performed experiments to assess the quality of the disclosed approach, and scalability of the approach when adding more workloads that may cause some disturbance in the allocations and execution times.

The experiment disclosed in FIG. 8 included changing the SLA for a single workload, and then assessing how the infrastructure assignment changed. As each infrastructure becomes more powerful than needed to meet the SLA requirements, it can be seen that the assignment changes to a smaller infrastructure, that is, a smaller number of cores. As shown, the initial allocation was 10 cores, then reduced to 4 cores, and finally to 2 cores. As shown in the lower graph, 2 cores are adequate to produce an execution time that is less than the SLA requirement. Note that while, in the example of FIG. 8, the infrastructure comprised cores, although other hardware and/or software infrastructure could have been used instead.

In the experiment indicated in FIG. 9, two workloads are involved that have the same SLA, that is, 3.6 cores. Thus, the optimum allocation for both workloads should be 4 cores but considering the interference the workloads may cause with each other, the second workload of the queue was allocated to the infrastructure with 10 cores, even though that allocation led to a higher error rate, that is, a greater differential between the execution and the SLA, than the error rate of slightly below zero associated with the use of 4 cores.

Turning now to FIG. 10, the indicated experiment included workloads with different respective SLAs. The best infrastructures to run the two workloads are the ones with 10 and 4 cores, respectively. Note that the error rate of wl₂ is not affected by the ending of wl₁, indicating that there is no interference between the infrastructures running the two workloads.

In the experiment indicated in FIG. 11, there are two workloads that each have the same SLA. Initially, wl₂ is allocated to the node with 10 cores, at the cost of a higher error rate. When wl₁ ends, wl₂ is reallocated to the node with 4 cores, reducing its error rate.

With reference next to FIG. 12, the indicated experiment included one workload starting during the execution of another workload. In this example, there is a third workload wl₃ starting and ending independently of the other workloads. This experiment shows that previous workloads in the same node does not affect the allocations after that workload ends.

In the experiment indicated in FIG. 13, there were three workloads, two of which initially have the same infrastructure allocation of 10 cores each. Since all the infrastructures have been allocated, there is an SLA violation for wl₂ during a few timestamps. After wl₃ ends, the system stabilizes itself by reallocating the cores that had been used by that workload to wl₂.

The experiment indicated in FIG. 14 is similar to that disclosed in FIG. 13. In the experiment of FIG. 14 however, there is one additional workload wl₄ running under a different SLA and, thus, was assigned to a different infrastructure.

### F. Further Discussion

Following is further discussion concerning aspects of some example embodiments. For example, the usage of the accumulators map is a low-cost solution for the workload placement problem and may lead to a more stable algorithm as compared with an implementation using only reinforcement learning. The accumulators map may solve the oscillation problem in these approaches and provides scalability, as demonstrated by the fact that, when running multiple workloads, the reward function outputs smaller rewards, which leads to smaller increments in the accumulators map and mitigates the priority of that infrastructure.

Further workload interference may be obtained indirectly. Since some embodiments may only consider the impact of a workload in a metric, such as execution time for example, there may be no need to actively model the interference of other workloads running in the same infrastructure. The interference may thus be effectively encoded inside the reward obtained by each execution. This concept may make this approach more general by assuming that the information about each workload and its bottlenecks is not needed.

Further, example embodiments may employ SLA-driven allocation of workload execution infrastructure. Each workload may be allocated infrastructure in a smart way, according to the needs of the particular workload. Thus, example embodiments may be resilient to SLA violations as consequence of an allocation that is not adequate to cope with the minimum requirements for each workload. On the other hand, example embodiments may provide a cost-effective allocation by avoiding allocations to infrastructures more powerful or capable than needed whenever is possible, that is, whenever the non-allocation may lead to an SLA violation.

Example embodiments may be configured such that an infrastructure allocation service need not be orchestrated inside a workload. Particularly, since example embodiments may only consider a metric, such as execution time for example, to provide infrastructure recommendations, there may be no need to create any kind of plugins to the workload in order to control it. The information about the execution and its correspondent reward may be enough to find the best allocation for each workload.

### G. Example Methods

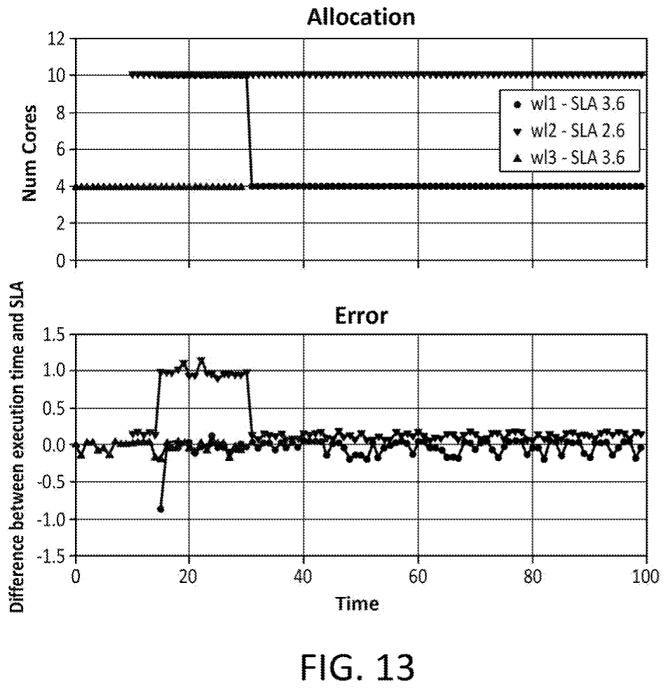

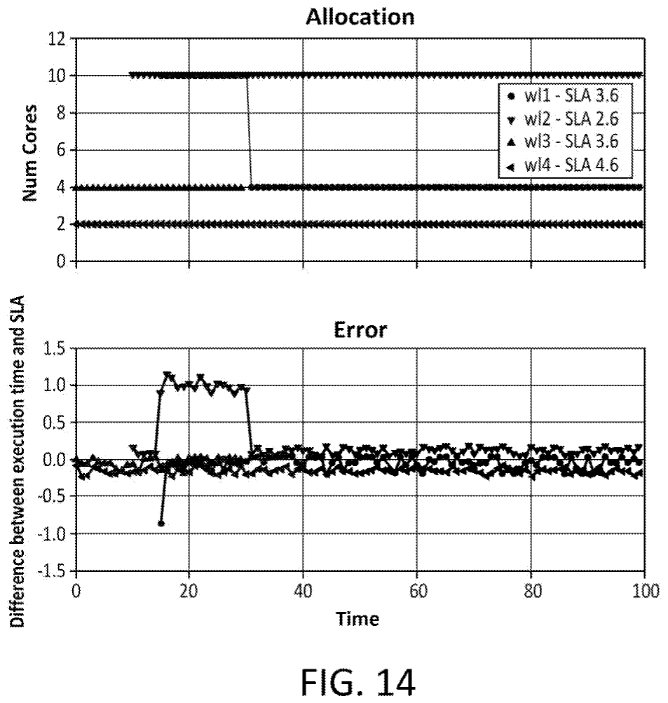

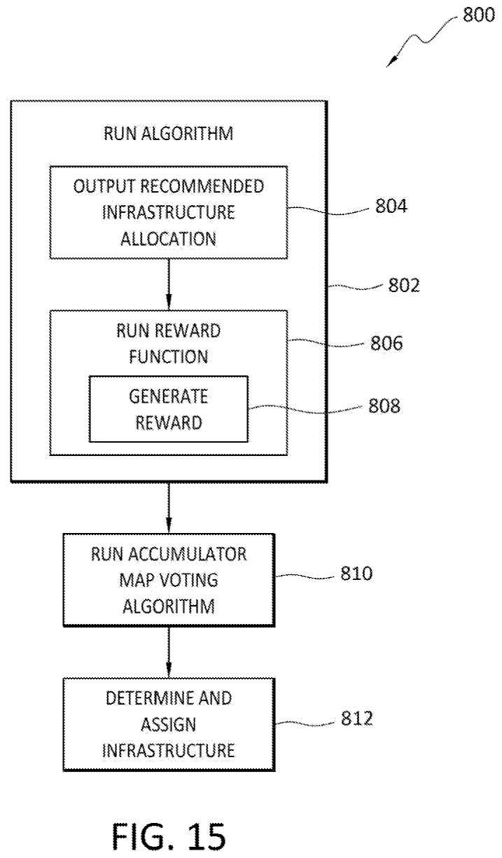

It is noted with respect to the example method of FIG. 15 that any of the disclosed processes, operations, methods, and/or any portion of any of these, may be performed in response to, as a result of, and/or, based upon, the performance of any preceding process(es), methods, and/or, operations. Correspondingly, performance of one or more processes, for example, may be a predicate or trigger to subsequent performance of one or more additional processes, operations, and/or methods. Thus, for example, the various processes that may make up a method may be linked together or otherwise associated with each other by way of relations such as the examples just noted.

Directing attention now to FIG. 15, the example method 800 may begin when an RL (Reinforcement Learning) algorithm is run 802. The RL algorithm may be a Deep Q-Network algorithm, although that is not necessarily required. The execution of the RL algorithm, which may be referred to as comprising a training process, may comprise running a number ‘n’ of iterations (where ‘n’ may be any non-zero integer) of a particular workload. The process 802 may comprise, for each of the ‘n’ iterations, outputting a recommended infrastructure allocation 804. After the recommended infrastructure allocation has been output 804, a reward function of the process 802 may be run 806 that generates a reward value 808, such that ‘n’ reward values may be generated, one for each of the ‘n’ infrastructures.

Thus, in this example, the process 802 may output both a recommended infrastructure allocation 804 and a reward value 808. Moreover, as noted, the process 802 may be run ‘n’ times to output ‘n’ infrastructure allocation recommendations, and ‘n’ associated reward values, one for each iteration ‘n’ of the workload. Thus, at the conclusion of ‘n’ iterations of 808, a respective pair (a,r), that is, (allocation,reward), may have been assigned to each of the ‘n’ workload iterations. It is noted that one or more of the infrastructure allocation recommendations may, or may not, be the same as one or more other infrastructure allocation recommendations.

After the reward value(s) 808 has/have been output, an accumulator map voting algorithm may then be run 810 which may operate to assign a summed reward value to each of the ‘n’ infrastructure allocations. Finally, at 812, the infrastructure allocation with the greatest total reward may be assigned to the workload.

### H. Further Example Embodiments

Following are some further example embodiments of the invention. These are presented only by way of example and are not intended to limit the scope of the invention in any way.

Embodiment 1. A method, comprising: running multiple iterations of a computing workload; for each iteration of the computing workload, using a reinforcement learning process to generate an initial infrastructure allocation for the computing workload, and a reward function of the reinforcement learning process generates a respective reward for each initial infrastructure allocation; running an accumulator map voting process to generate a total reward for each initial infrastructure allocation; and identifying the initial infrastructure allocation with the largest total reward and assigning that initial infrastructure allocation to the computing workload.

Embodiment 2. The method as recited in embodiment 1, wherein the reinforcement learning process comprises a Deep Q-Network reinforcement learning process.

Embodiment 3. The method as recited in any of embodiments 1-2, wherein one of the rewards has a value that indicates a relation between an execution time of the computing workload and an execution time specified by a service level agreement, and the execution time of the computing workload is the time taken for execution of the computing workload by the initial infrastructure allocation to which the reward value corresponds.

Embodiment 4. The method as recited in any of embodiments 1-3, wherein running the reward function identifies, for each of the initial infrastructure allocations, one of: computing resource wastage; a service level agreement violation; or, conformance with a service level agreement requirement.

Embodiment 5. The method as recited in any of embodiments 1-4, wherein a reward value of zero for an initial infrastructure allocation indicates that computing resources included in that initial infrastructure allocation exceed the computing resources needed to execute the computing workload in a manner that meets requirements of a service level agreement.

Embodiment 6. The method as recited in any of embodiments 1-5, wherein a negative reward value for an initial infrastructure allocation indicates that computing resources included in that initial infrastructure allocation are inadequate to execute the computing workload in a manner that meets requirements of a service level agreement.

Embodiment 7. The method as recited in any of embodiments 1-6, wherein a reward value for an initial infrastructure allocation is at a maximum at a point between a zero reward value and a negative reward value.

Embodiment 8. The method as recited in any of embodiments 1-7, wherein inputs to the reward function comprise an execution time x of an epoch of the workload, a service level agreement value μ, and a parameter σ that defines how quickly a reward curve decays.

Embodiment 9. The method as recited in any of embodiments 1-8, wherein a plot of the reward function comprises a reward band that includes a range of reward values, and each of the reward values in the reward band corresponds to an initial infrastructure allocation that is capable of executing the computing workload according to a requirement specified in a service level agreement.

Embodiment 10. The method as recited in embodiment 9, wherein the reward band includes a positive reward value, a maximum reward value, and a negative reward value.

Embodiment 11. A method for performing any of the operations, methods, or processes, or any portion of any of these, disclosed herein.

Embodiment 12. A computer readable storage medium having stored therein instructions that are executable by one or more hardware processors to perform operations comprising the operations of any one or more of embodiments 1-11.

### I. Example Computing Devices and Associated Media

The embodiments disclosed herein may include the use of a special purpose or general-purpose computer including various computer hardware or software modules, as discussed in greater detail below. A computer may include a processor and computer storage media carrying instructions that, when executed by the processor and/or caused to be executed by the processor, perform any one or more of the methods disclosed herein, or any part(s) of any method disclosed.

As indicated above, embodiments within the scope of the present invention also include computer storage media, which are physical media for carrying or having computer-executable instructions or data structures stored thereon. Such computer storage media may be any available physical media that may be accessed by a general purpose or special purpose computer.

By way of example, and not limitation, such computer storage media may comprise hardware storage such as solid state disk/device (SSD), RAM, ROM, EEPROM, CD-ROM, flash memory, phase-change memory (“PCM”), or other optical disk storage, magnetic disk storage or other magnetic storage devices, or any other hardware storage devices which may be used to store program code in the form of computer-executable instructions or data structures, which may be accessed and executed by a general-purpose or special-purpose computer system to implement the disclosed functionality of the invention. Combinations of the above should also be included within the scope of computer storage media. Such media are also examples of non-transitory storage media, and non-transitory storage media also embraces cloud-based storage systems and structures, although the scope of the invention is not limited to these examples of non-transitory storage media.

Computer-executable instructions comprise, for example, instructions and data which, when executed, cause a general purpose computer, special purpose computer, or special purpose processing device to perform a certain function or group of functions. As such, some embodiments of the invention may be downloadable to one or more systems or devices, for example, from a website, mesh topology, or other source. As well, the scope of the invention embraces any hardware system or device that comprises an instance of an application that comprises the disclosed executable instructions.

Although the subject matter has been described in language specific to structural features and/or methodological acts, it is to be understood that the subject matter defined in the appended claims is not necessarily limited to the specific features or acts described above. Rather, the specific features and acts disclosed herein are disclosed as example forms of implementing the claims.

As used herein, the term ‘module’ or ‘component’ may refer to software objects or routines that execute on the computing system. The different components, modules, engines, and services described herein may be implemented as objects or processes that execute on the computing system, for example, as separate threads. While the system and methods described herein may be implemented in software, implementations in hardware or a combination of software and hardware are also possible and contemplated. In the present disclosure, a ‘computing entity’ may be any computing system as previously defined herein, or any module or combination of modules running on a computing system.

In at least some instances, a hardware processor is provided that is operable to carry out executable instructions for performing a method or process, such as the methods and processes disclosed herein. The hardware processor may or may not comprise an element of other hardware, such as the computing devices and systems disclosed herein.

In terms of computing environments, embodiments of the invention may be performed in client-server environments, whether network or local environments, or in any other suitable environment. Suitable operating environments for at least some embodiments of the invention include cloud computing environments where one or more of a client, server, or other machine may reside and operate in a cloud environment.

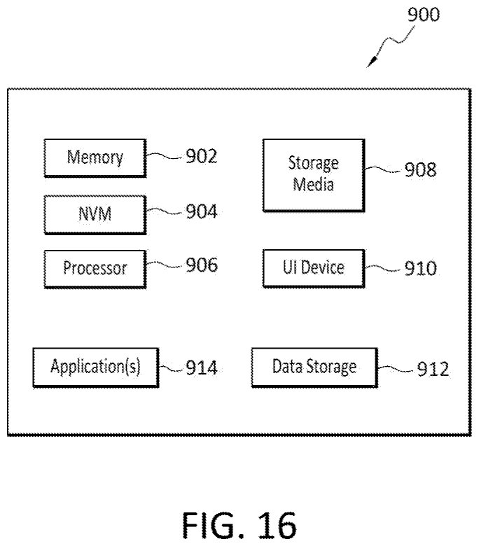

With reference briefly now to FIG. 16, any one or more of the entities disclosed, or implied, by FIGS. 1-15 and/or elsewhere herein, may take the form of, or include, or be implemented on, or hosted by, a physical computing device, one example of which is denoted at 900. As well, where any of the aforementioned elements comprise or consist of a virtual machine (VM), that VM may constitute a virtualization of any combination of the physical components disclosed in FIG. 16.

In the example of FIG. 16, the physical computing device 900 includes a memory 902 which may include one, some, or all, of random access memory (RAM), non-volatile memory (NVM) 904 such as NVRAM for example, read-only memory (ROM), and persistent memory, one or more hardware processors 906, non-transitory storage media 908, UI device 910, and data storage 912. One or more of the memory components 902 of the physical computing device 900 may take the form of solid state device (SSD) storage. As well, one or more applications 914 may be provided that comprise instructions executable by one or more hardware processors 906 to perform any of the operations, or portions thereof, disclosed herein.

Such executable instructions may take various forms including, for example, instructions executable to perform any method or portion thereof disclosed herein, and/or executable by/at any of a storage site, whether on-premises at an enterprise, or a cloud computing site, client, datacenter, data protection site including a cloud storage site, or backup server, to perform any of the functions disclosed herein. As well, such instructions may be executable to perform any of the other operations and methods, and any portions thereof, disclosed herein.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method, comprising:
running multiple iterations of a computing workload;
for each iteration of the computing workload, using a reinforcement learning process to generate an initial infrastructure allocation for the computing workload, and a reward function of the reinforcement learning process generates a respective reward for each initial infrastructure allocation;
running an accumulator map voting process to generate a total reward for each initial infrastructure allocation; and
identifying the initial infrastructure allocation with the largest total reward and assigning that initial infrastructure allocation to the computing workload.

2. The method as recited in claim 1, wherein the reinforcement learning process comprises a Deep Q-Network reinforcement learning process.

3. The method as recited in claim 1, wherein one of the rewards has a value that indicates a relation between an execution time of the computing workload and an execution time specified by a service level agreement, and the execution time of the computing workload is the time taken for execution of the computing workload by the initial infrastructure allocation to which the reward value corresponds.

4. The method as recited in claim 1, wherein running the reward function identifies, for each of the initial infrastructure allocations, one of: computing resource wastage; a service level agreement violation; or, conformance with a service level agreement requirement.

5. The method as recited in claim 1, wherein a reward value of zero for an initial infrastructure allocation indicates that computing resources included in that initial infrastructure allocation exceed the computing resources needed to execute the computing workload in a manner that meets requirements of a service level agreement.

6. The method as recited in claim 1, wherein a negative reward value for an initial infrastructure allocation indicates that computing resources included in that initial infrastructure allocation are inadequate to execute the computing workload in a manner that meets requirements of a service level agreement.

7. The method as recited in claim 1, wherein a reward value for an initial infrastructure allocation is at a maximum at a point between a zero reward value and a negative reward value.

8. The method as recited in claim 1, wherein inputs to the reward function comprise an execution time x of an epoch of the workload, a service level agreement value μ, and a parameter o that defines how quickly a reward curve decays.

9. The method as recited in claim 1, wherein a plot of the reward function comprises a reward band that includes a range of reward values, and each of the reward values in the reward band corresponds to an initial infrastructure allocation that is capable of executing the computing workload according to a requirement specified in a service level agreement.

10. The method as recited in claim 9, wherein the reward band includes a positive reward value, a maximum reward value, and a negative reward value.

11. A computer readable storage medium having stored therein instructions that are executable by one or more hardware processors to perform operations comprising:
running multiple iterations of a computing workload;
for each iteration of the computing workload, using a reinforcement learning process to generate an initial infrastructure allocation for the computing workload, and a reward function of the reinforcement learning process generates a respective reward for each initial infrastructure allocation;
running an accumulator map voting process to generate a total reward for each initial infrastructure allocation; and
identifying the initial infrastructure allocation with the largest total reward and assigning that initial infrastructure allocation to the computing workload.

12. The computer readable storage medium as recited in claim 11, wherein the reinforcement learning process comprises a Deep Q-Network reinforcement learning process.

13. The computer readable storage medium as recited in claim 11, wherein one of the rewards has a value that indicates a relation between an execution time of the computing workload and an execution time specified by a service level agreement, and the execution time of the computing workload is the time taken for execution of the computing workload by the initial infrastructure allocation to which the reward value corresponds.

14. The computer readable storage medium as recited in claim 11, wherein running the reward function identifies, for each of the initial infrastructure allocations, one of: computing resource wastage; a service level agreement violation; or, conformance with a service level agreement requirement.

15. The computer readable storage medium as recited in claim 11, wherein a reward value of zero for an initial infrastructure allocation indicates that computing resources included in that initial infrastructure allocation exceed the computing resources needed to execute the computing workload in a manner that meets requirements of a service level agreement.

16. The computer readable storage medium as recited in claim 11, wherein a negative reward value for an initial infrastructure allocation indicates that computing resources included in that initial infrastructure allocation are inadequate to execute the computing workload in a manner that meets requirements of a service level agreement.

17. The computer readable storage medium as recited in claim 11, wherein a reward value for an initial infrastructure allocation is at a maximum at a point between a zero reward value and a negative reward value.

18. The computer readable storage medium as recited in claim 11, wherein inputs to the reward function comprise an execution time x of an epoch of the workload, a service level agreement value μ, and a parameter o that defines how quickly a reward curve decays.

19. The computer readable storage medium as recited in claim 11, wherein a plot of the reward function comprises a reward band that includes a range of reward values, and each of the reward values in the reward band corresponds to an initial infrastructure allocation that is capable of executing the computing workload according to a requirement specified in a service level agreement.

20. The computer readable storage medium as recited in claim 19, wherein the reward band includes a positive reward value, a maximum reward value, and a negative reward value.
